(19) United States
(12) Patent Application Publication
(10) Pub. No.: US 2007/0211085 A1
(43) Pub. Date: Sep. 13, 2007

(54) Method and Apparatus for Displaying Monochrome Images on a Color Monitor

(75) Inventor: Adam Kornel Galant, Carpentersville, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 11/674,226

(22) Filed: Feb. 13, 2007

Related U.S. Application Data
(60) Provisional application No. 60/781,788, filed on Mar. 13, 2006.

(51) Int. Cl. G09G 5/10

(52) U.S. Cl. 345/690

(57) ABSTRACT

Disclosed is a method for increasing the number of grey levels used to create a monochrome image on a color display which comprises pixels with individual red, green, and blue color components. If the luminance value of each color component is controlled by an n-bit value, the number of true monochrome grey levels resulting from equal control values of each color is 2ⁿ. By adjusting the luminance of each color component such that the luminances of at least two color components are different from each other, intermediate values of luminance may be formed. Under specified conditions, the resulting light emission has intermediate luminance values which are perceived by human vision, and color values which are still perceived as grey. The resulting number of perceived grey levels is greater than 2ⁿ.

This application claims the benefit of U.S. Provisional Application No. 60/781,788 filed Mar. 13, 2006, which is incorporated herein by reference.

### BACKGROUND OF THE INVENTION

The present invention relates generally to display systems, and more particularly to display of monochrome images on a color monitor.

Images used for medical diagnostics, such as those produced by X-Ray Imaging and Magnetic Resonance Imaging, are commonly displayed as monochrome images. Since output intensities of the signals from the diagnostic instrument (e.g., X-Ray detector) are captured as grey levels, an imaging medium with a wide dynamic range of grey levels is essential for high resolution. Photographic film has been the standard medium. Strictly, “monochrome image” refers to an image of a single color. Herein, “monochrome image” refers to images formed by shades of grey, inclusive of black and white.

Photographic images, however, have a number of disadvantages: (a) the film must be stored under controlled environmental conditions to avoid deterioration; (b) large quantities of film require considerable storage space; (c) reproduction requires processing a new copy of the film; and (d) transmitting images to different people for analysis requires physical delivery of the film. To alleviate these problems, the growing trend is to store the images in digital form, thereby facilitating reproduction, transmission, and archival storage. One widely used industry standard for the exchange, transmission, and display of medical images is Digital Imaging In Communications and Medicine (DICOM).

Although specialized equipment for displaying medical images is available, a standard personal computer (PC) with a color display provides a convenient, low-cost option. Color displays create images via an array of individual picture elements (pixels). Each pixel comprises three color components which emit red (R), green (G), or blue (B) light. The luminance of each color component in each pixel may be varied independently. By mixing color components of varying luminance, a wide spectrum of colors may be produced. The images are controlled by a video interface card which transforms the output of the PC image processing software into electronic signals which control the luminance of each pixel color component.

The luminance of each pixel color component in the display is not continuous. The luminance of each pixel color component is controlled by a discrete set of n-bit control values generated by the output of a video interface card. A common control value in video interface cards has 8 bits. The luminance of each color component, then, has a range of 256 discrete values. If the luminance of each R, G, B color component in a pixel is equal, the resulting image is a shade of grey, inclusive of black and white. The shade of grey is set by the total luminance of the combined color components. An 8-bit control value, then, will produce only 256 discrete grey levels. This is inadequate for medical imaging; in particular, the DICOM standard recommends 1024 grey levels [DICOM Part 14. Grayscale Standard Display Function].

To overcome the limitation of the number of grey levels in the display, the signal levels, which are represented as digital image values, may be mapped to different colors as well as luminance. In the method of U.S. Pat. No. 6,906,727, the digital image values are mapped to unique points in a three-dimensional color space. Two axes (xy) define the color value; the third axis, intensity. The values of (xy) are deliberately chosen to create a spectrum of discernable color values centered on a reference value. The same sequence of colors is cyclically reused at different intensity levels. The mapping of a digital image value to a point in color space is provided by a look-up table, which is constructed experimentally. In the method disclosed in the U.S. Pat. No. 6,906,727, the input signal levels are not represented in a consistent manner. If the difference in input signal levels is sufficiently large, the difference on the display is shown as a difference in grey levels. If the difference in input signal values is sufficiently small, the difference on the display is shown as a difference in color values.

What is needed is a method for displaying input signal levels consistently as a series of grey levels on a color monitor. The number of grey levels need to be greater than the number of grey levels provided by the limited resolution of an 8-bit control value; in particular, 1024 grey levels are needed to meet the DICOM recommendation.

### BRIEF SUMMARY OF THE INVENTION

This invention takes advantage of the recognition that human vision perceives luminance differently for different colors, and is less sensitive to color value than to total luminance. For a color display comprising an array of pixels with individual red, green, and blue color components, true grey levels are created by setting the luminances of all three color components to be equal. If the luminance of each color component is controlled by an n-bit control number, the number of true grey levels is limited to 2ⁿ In accordance with an advantage of the invention, the total number of perceived grey levels is increased by relaxing the constraint that the luminances of all three colors be equal. In accordance with one embodiment of the invention, new color combinations are created in which the total luminances of each color combination are discernable by the human eye and, at the same time, in which the color value of each color combination is not substantially discernable from grey. In an embodiment of the invention, the number of perceived grey levels is increased from 256 to 1786 for a display in which the luminance of each color component is independently controlled by an 8-bit control number.

One embodiment of the invention provides a technique for increasing the perceived monochrome luminance values on a color display system that is capable of displaying a plurality of pixels, where each pixel is made up of a red, blue, and green color component, where the luminance of each color component is independently controllable according to an n-bit control value, and where each pixel is capable of displaying a plurality of true monochrome luminance values by setting the luminance of each color component of a pixel to the same n-bit control value, thereby allowing the display of 2ⁿ true monochrome luminance values. In accordance with this embodiment, digital image values comprising greater than 2ⁿ true monochrome luminance values are received. Intermediate perceived monochrome luminance values between the true monochrome luminance values are generated by varying the n-bit control values of the color components of a pixel such that at least two of the n-bit control values of the color components of the pixel are different from each other.

These and other advantages of the invention will be apparent to those of ordinary skill in the art by reference to the following detailed description and the accompanying drawings.

### BRIEF DESCRIPTION OF THE DRAWINGS

FIG. 1 shows an exemplary imaging system in which the principles of the present invention may be implemented;

FIG. 2 is a flowchart of steps to transform a digital image value to a set of control values;

FIG. 3 shows a method for generating six intermediate perceived monochrome luminance values between two sequential true monochrome luminance values;

FIG. 4 shows a method for transforming a digital image value to a perceived monochrome luminance level via a look-up table;

FIG. 5 shows an algorithm for transforming a digital image value to a perceived monochrome luminance level;

FIG. 6 shows a method for transforming the least significant bits of a digital image value to an intermediate perceived monochrome level; and

FIG. 7 shows an embodiment of a signal processing system comprising a personal computer.

### DETAILED DESCRIPTION OF EXEMPLARY EMBODIMENTS

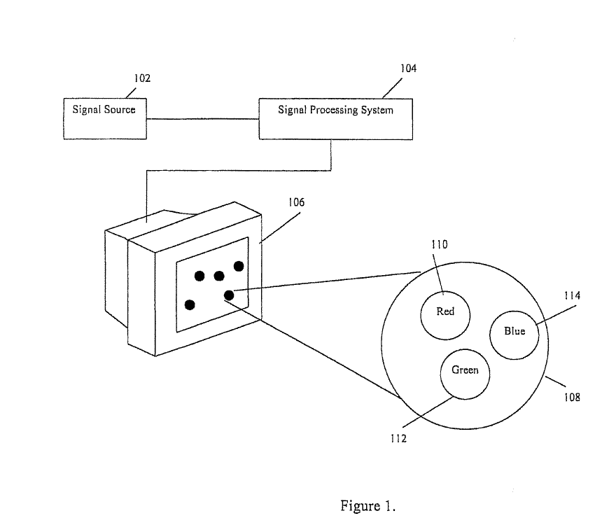

FIG. 1 shows an exemplary configuration in which the principles of embodiments of the present invention may be implemented. Signal source 102 transmits digital image values to signal processing system 104. An example of a signal source is an X-Ray imaging system. The digital image values are proportional to the intensity of the X-Ray signals. The signal processing system 104 transforms the digital image values to digital control values which drive display 106.

Signal processing system 104 may be any system comprising a processor, hardware, firmware, and software to transform input signals from signal source 102 to output signals to display 106. Display 106 may be any type of color monitor comprising a display controller and a screen displaying an array of pixels with red (R), green (G), and blue (B) color components. Examples of displays include cathode ray tubes (CRTs), liquid crystal displays (LCDs), and plasma panel displays. Display 106 comprise analog monitors and digital monitors.

In FIG. 1, pixel 108 in display 106 comprises individual color components red 110, green 112, and blue 114. The luminance of each color component is independently controllable by an n-bit control value generated by signal processing system 104. Herein, “total luminance” of a pixel refers to the combined luminances of all three color components. When the luminances of each R, G, B color component in a pixel are all equal, a monochrome (grey) light is generated, wherein grey is inclusive of black and white. The shade of grey is proportional to the total luminance. Herein, the total luminance of a pixel wherein the luminance of each R, G, B color component is equal shall be referred to as a “true monochrome luminance.”

The luminance of each color component is not continuous. With an n-bit control value, there are 2ⁿ discrete values. With the constraint that the luminance of each R, G, B color component be equal, there are 2ⁿ discrete values of true monochrome luminance. The luminances of each R, G, B color component of a pixel are set to be equal by setting the control values for each R, G, B color component to be the same. This invention generates values of intermediate perceived monochrome luminance between sequential values of true monochrome luminance by relaxing the constraint for true monochrome luminance. If the luminances of the R, G, B color components are each varied independently in a controlled manner as described herein below, the resulting differences in total luminance are discernable (noticeable by human vision); however, the resulting differences in color value are not substantially discernable from grey.

Herein, “not substantially discernable from grey” means that an average human observer viewing an image under typical viewing conditions, such as in an office, would not discern the color value from grey. Under specific viewing conditions, however, an average human observer may, upon close scrutiny of the image, discern a just-noticeable difference between the color value and grey. Herein, the term “intermediate perceived monochrome luminance” shall refer to the total luminance of a pixel which satisfies the following conditions: (a) the luminance of at least two of the R, B, G color components differ from each another, (b) the color of the pixel is not substantially discernable from grey, and (c) the total luminance is an intermediate value between two sequential values of true monochrome luminance. The condition wherein the luminance of at least two of the R, G, B color components are different from each other is created by varying the n-bit control values of the R, G, B color components such that at least two of the n-bit control values are different from each other. Herein, the term “perceived monochrome luminance” shall be inclusive of both true monochrome luminance and intermediate perceived monochrome luminance. Herein, a digital image value is transformed into a perceived monochrome luminance value by a signal processing system.

The objective of the display system shown in FIG. 1 is to provide a one-to-one mapping between a digital image value and a perceived monochrome luminance value. If a digital image value is represented by a d-bit number, there are 2^{d} discrete values of digital image values. For a display in which the luminance of each R, G, B color component is controlled by a n-bit control number, there are 2ⁿ discrete values of true monochrome luminance values. If d is greater than n, a one-to-one mapping between the set of digital image values and the set of true monochrome luminance values is not possible. In this instance, the set of 2^{d} discrete digital image values must be compressed into a set of 2ⁿ discrete true monochrome luminance values, resulting in loss of resolution of digital image values. One embodiment of the invention generates a number of discrete values of perceived monochrome luminance that is greater than 2ⁿ discrete true monochrome luminance values, thereby reducing the loss of resolution of digital image values.

The output from signal processing system 104 comprises a set of three independent n-bit control values, one for each R, G, B color component. In an embodiment of the invention in which the control values are 8-bit numbers, the maximum number of true monochrome luminance values which may be generated on display 106 is 256. One embodiment of the invention generates six values of intermediate perceived monochrome luminance between two sequential true monochrome luminance values.

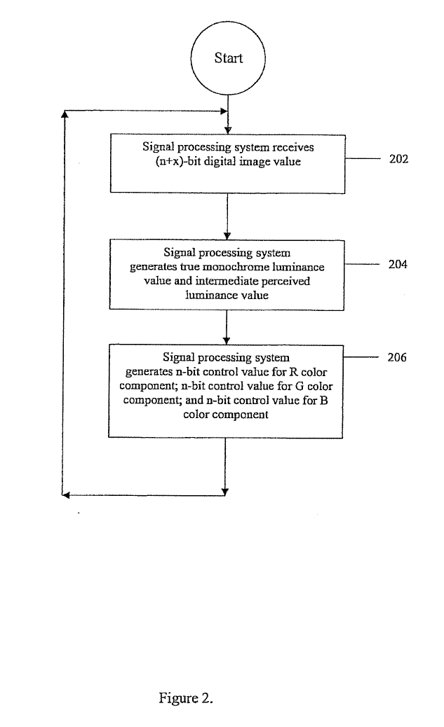

FIG. 2 is a flowchart of an embodiment of the invention in which a digital image value is transformed into an initial perceived monochrome luminance value and then into a final set of n-bit control values, one for each R, G, B component. In Step 202, signal processing system receives (n+x)-bit digital image value from signal source, where n is the bit length of a control value output by signal processing system, and x is an integer greater than zero.

In Step 204, signal processing system generates perceived monochrome luminance corresponding to n-bit true monochrome luminance which is less than or equal to (n+x)-bit digital image value and intermediate perceived monochrome value corresponding to (n+x)-bit digital image value. In Step 206, signal processing system transforms perceived monochrome luminance value into set of three independent n-bit control values, one for each R, G, B color component. The process then returns to start to process the next digital image value. Details for one embodiment of the process shown are described below.

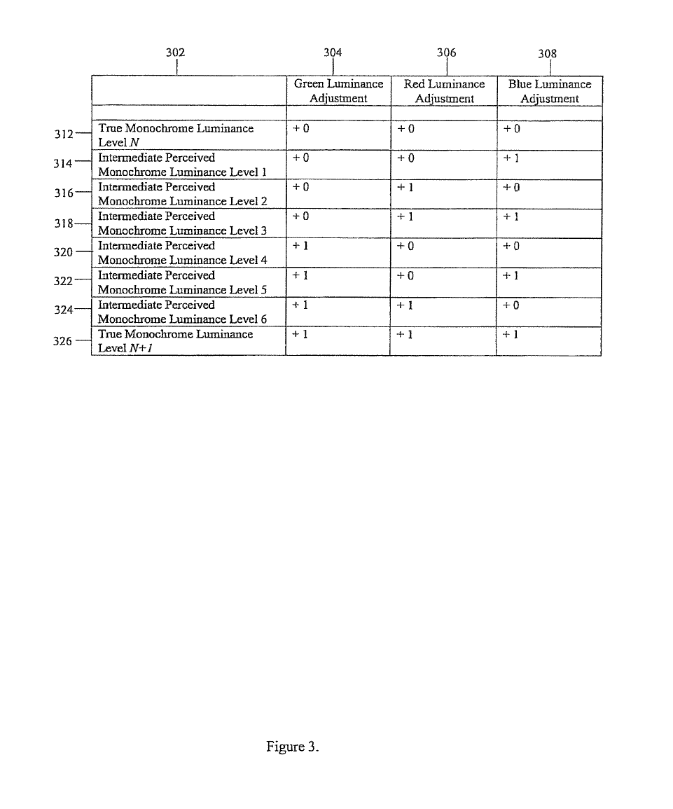

In the embodiment shown in FIG. 3, the control value of each R, G, B color component is an independent n-bit number, and N is the decimal value of one of the 2ⁿ control values. For an 8-bit control value, N runs from 0 to 255. The true monochrome luminance level N shown in the cell (row 312, column 302) is the value of true monochrome luminance generated by setting the decimal values of the 8-bit control values of each of the R, G, B color components equal to the value N. Similarly, the next sequential true monochrome luminance level, N+1, is shown in the cell (row 326, column 302).

The cells in (rows 314 through 324, column 302) lists six levels of intermediate perceived monochrome luminance generated between true monochrome luminance level N, cell (row 312, column 302), and the next sequential true monochrome luminance level N+1, cell (row 326, column 302). The six levels of intermediate perceived monochrome luminance are denoted intermediate perceived monochrome luminance level 1, cell (row 314, column 302) through intermediate perceived luminance level 6, cell (row 324, column 302).

The embodiment in FIG. 3 shows the generation of intermediate perceived monochrome luminance level 1, cell (row 314, column 302), through intermediate perceived monochrome luminance level 6, cell (row 324, column 302), by adjusting the independent 8-bit control values for the individual R, G, B color components in the sequence shown herein. Column 304 lists the green luminance adjustment values to generate intermediate perceived monochrome luminance level 1, cell (row 314, column 302) through intermediate perceived monochrome luminance level 6, cell (row 324, column 302). Column 306 lists the red luminance adjustment values to generate intermediate perceived monochrome luminance level 1, cell (row 314, column 302), through intermediate perceived monochrome luminance level 6, cell (row 324, column 302). Column 308 lists the blue luminance adjustment values to generate intermediate perceived monochrome luminance level 1, cell (row 314, column 302) through intermediate perceived monochrome luminance level 6, cell (row 324, column 302). The luminance adjustment of each color component comprises adding zero bit or 1 bit to the 8-bit control value for the color component. In FIG. 3, adjustment values shown in the cells (row 312, column 304) through (row 326, column 308) are denoted +0 for adding 0 bit and +1 for adding 1 bit. The bits are added to the 8-bit control value for each R, G, B color component of true monochrome luminance level N, cell (row 312, column 302).

Herein, by definition, for true monochrome luminance level N, cell (row 312, column 302), the adjustment values of the luminance values of each color [cell (row 312, column 304), cell (row 312, column 306), and cell (row 312, column 308)] are all equal to +0. Herein, by definition, for true monochrome luminance level N+1, cell (row 326, column 302), the adjustment values of the luminance values of each color [cell (row 326, column 304), cell (row 326, column 306), and cell (row 326, column 308)] are all equal to +1.

For intermediate perceived monochrome luminance level 1, cell (row 314, column 302), the corresponding adjustment values are +0 for the green luminance adjustment, cell (row 314, column 304), +0 for the red luminance adjustment, cell (row 314, column 306), and +1 for the blue luminance adjustment, cell (row 314, column 308).

For intermediate perceived monochrome luminance level 2, cell (row 316, column 302), the corresponding adjustment values are +0 for the green luminance adjustment, cell (row 316, column 304), +1 for the red luminance adjustment, cell (row 316, column 306), and +0 for the blue luminance adjustment, cell (row 316, column 308).

For intermediate perceived monochrome luminance level 3, cell (row 318, column 302), the corresponding adjustment values are +0 for the green luminance adjustment, cell (row 318, column 304), +1 for the red luminance adjustment, cell (row 318, column 306), and +1 for the blue luminance adjustment, cell (row 318, column 308).

For intermediate perceived monochrome luminance level 4, cell (row 320, column 302), the corresponding adjustment values are +1 for the green luminance adjustment, cell (row 320, column 304), +0 for the red luminance adjustment, cell (row 320, column 306), and +0 for the blue luminance adjustment, cell (row 320, column 308).

For intermediate perceived monochrome luminance level 5, cell (row 322, column 302), the corresponding adjustment values are +1 for the green luminance adjustment, cell (row 322, column 304), +0 for the red luminance adjustment, cell (row 322, column 306), and +1 for the blue luminance adjustment, cell (row 322, column 308).

For intermediate perceived monochrome luminance level 6, cell (row 324, column 302), the corresponding adjustment values are +1 for the green luminance adjustment, cell (row 324, column 304), +1 for the red luminance adjustment, cell (row 324, column 306), and +0 for the blue luminance adjustment, cell (row 324, column 308).

The embodiment shown in FIG. 3 is based on the fact that the sensitivity of human vision is a function of color; it is most sensitive to green and least sensitive to blue. In addition, human vision is more sensitive to changes in total luminance than to changes in color value. This is expressed by the Kodak formula for converting the luminance of the individual R, G, B color components to total luminance:

I_{T}=0.3I_{R}+0.586I_{G}+0.113I_{B}, where

I_{T} is the total luminance, I_{R} is the luminance of the red color component, I_{G} is the luminance of the green color component, and I_{B} is the luminance of the blue color component. Measurements show that, with the embodiment shown in FIG. 3, the color value of the intermediate perceived monochrome levels is not substantially discernable from grey, and that the intermediate perceived monochrome luminance values increase linearly as the intermediate perceived monochrome luminance levels increase from level 1 to level 6. This holds true even near zero total luminance (black) where a 1-bit adjustment represents a relatively large difference.

With an 8-bit control value, the embodiment shown in FIG. 3 increases the total number of perceived monochrome luminance levels from 256 to 1786, which exceeds the DICOM recommendation of 1024. The total number of perceived monochrome luminance values is calculated as follows. With an 8-bit control value, there are 256 true monochrome values. For each true monochrome luminance value greater than or equal to zero and less than or equal to 254, there are six intermediate perceived monochrome values. Hence, the total number of perceived monochrome luminance values is equal to the sum of 256 and the product of 6 multiplied by 255. This sum is equal to 1786. Note that the luminance value of 255 is the maximum value that can be output by the video interface card; therefore, there are no intermediate perceived monochrome luminance values above a true monochrome luminance value of 255.

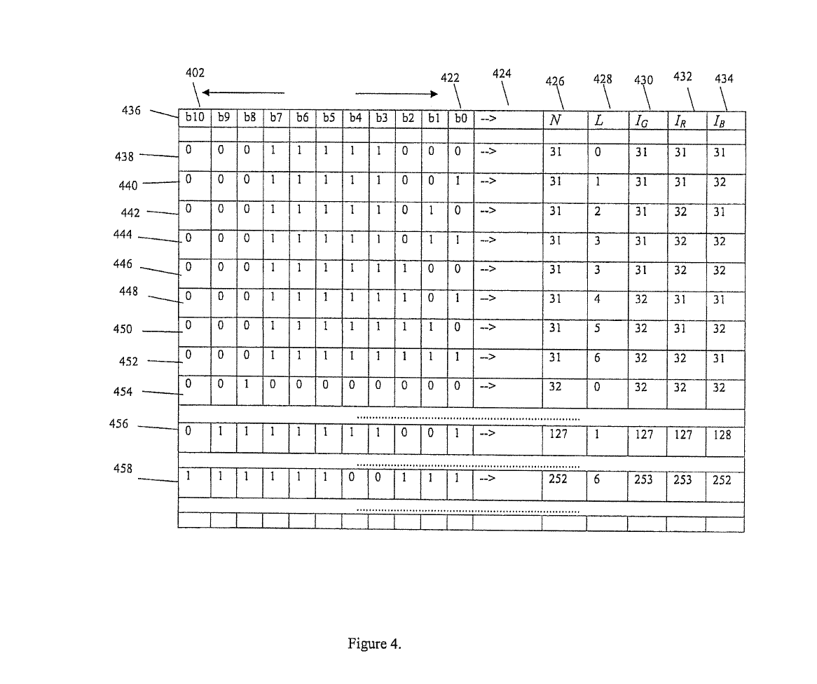

FIG. 4 shows a method for implementing an embodiment of the invention. An 11-bit digital image value is transformed via a look-up table into an initial set of true monochrome luminance level and intermediate perceived monochrome luminance level and then into a final set of three 8-bit control values, one for each R, G, B color component. FIG. 4 shows only a portion of the complete look-up table. Row 436 provides the column headings for the table. Columns 402 through 422 are the 11 bits of the digital image values which are input into a signal processing system from a signal source. The digital image values are expressed as binary numbers. Column 424 indicates the look-up function. Column 426 is the true monochrome luminance level N that is less than or equal to the digital image value. The value of N is expressed as a decimal number ranging from 0 to 255. Column 428 is the intermediate perceived monochrome luminance level. The value of L is expressed as a decimal number ranging from 0-6, where L=0 is a degenerate case for a true monochrome luminance value. Column 430 is the luminance value I_{G} of the green color component. The value of I_{G} is a decimal number ranging from 0 to 255. The binary number corresponding to I_{G} is the 8-bit control value for the luminance level of the green color component. Column 432 is the luminance value I_{R} of the red color component. The value of I_{R} is a decimal number ranging from 0 to 255. The binary number corresponding to I_{R} is the 8-bit control value for the luminance level of the red color component. Column 434 is the luminance value I_{B} of the blue color component. The value of I_{B} is a decimal number ranging from 0 to 255. The binary number corresponding to I_{B} is the 8-bit control value for the luminance level of the green color component. The set of three 8-bit control values, one for each R, G, B component, generates the set of 1786 perceived monochrome luminance values.

In the example shown in FIG. 4, there are 2¹¹=2048 unique digital image values; whereas, there are only 1786 unique perceived monochrome luminance values. Therefore, some instances of perceived monochrome luminance values will correspond to more than one instance of digital image values. Rows 438 through 458 are instances of digital image values and the corresponding instances of perceived monochrome luminance values provided by the look-up table. In particular, note that the digital image values in row 444 and 446 are mapped into the same perceived monochrome luminance value of N=31, L=3.

One skilled in the art will be able to build a complete look-up table for transforming an 11-bit digital image value to a set of three 8-bit control values, one for each R, G, B color component. One skilled in the art will be able to build a complete look-up table for transforming a digital image value with a bit length of (n+x) into a set of three control values with bit lengths of n, one for each R, G, B color component, where x is an integer greater than 0.

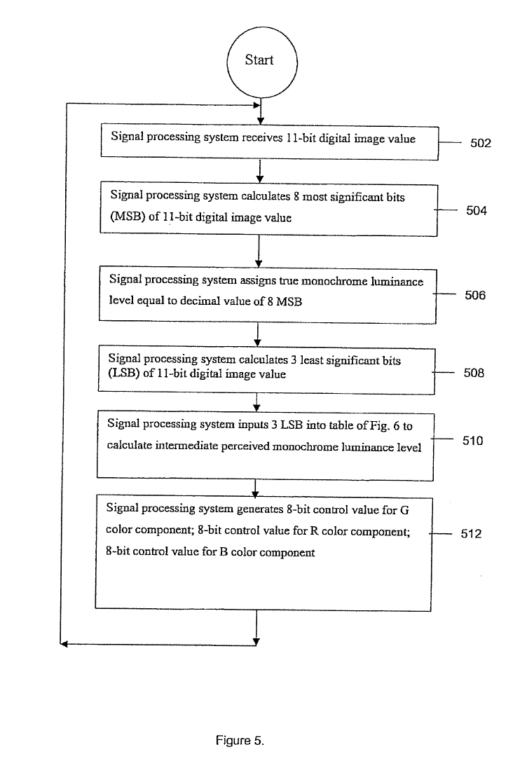

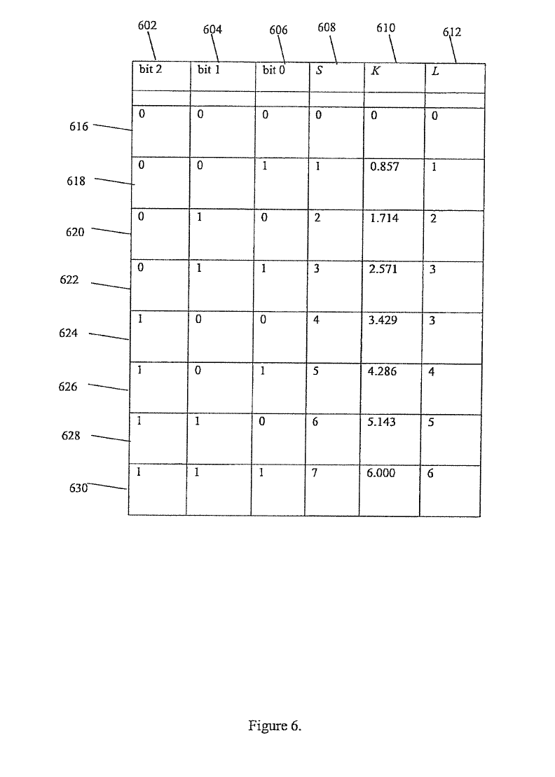

FIG. 5 shows another method for implementing an embodiment of the invention. An 11-bit digital image value is transformed via an algorithm into an initial set of true monochrome luminance level and intermediate perceived monochrome luminance level and then into a final set of three 8-bit control values, one for each R, G, B color component. FIG. 5 shows a flowchart for executing the algorithm. In step 502, signal processing system receives 11-bit digital image value from signal source. In step 504, signal processing system calculates the 8 most significant bits (MSB) of the 11-bit digital image value. In step 506, signal processing system assigns the true monochrome luminance level equal to the decimal value of 8 MSB. In step 508, signal processing system calculates the 3 least significant bits (LSB) of the 11-bit digital image value. In step 510, signal processing system inputs 3 LSB into table of FIG. 6 to calculate intermediate perceived monochrome luminance level. In step 512, signal processing system generates set of three 8-bit control values, one for each R, G, B component.

FIG. 6 shows a table for transforming the 3 LSB into an intermediate perceived monochrome luminance level. Columns 602, 604, and 606 are the bit values of the 3 LSB. Column 608 is S, the decimal value of the 3-bit binary number. Column 610 is the value of K, which is equal to the product of S multiplied by ( 6/7). This multiplication step compresses the seven non-zero values of S into the 6 non-zero values of L. Column 612 is the value of L, which is the value of S rounded to the nearest integer. The value L is the intermediate perceived monochrome luminance level. The value of L=0 is a degenerate case for a true monochrome luminance value. Rows 616 through 630 show the 8 possible 3-bit binary numbers and the corresponding values of S, K, and L. Note that S equal to 3 and S equal to 4 are both rounded to L equal to 3.

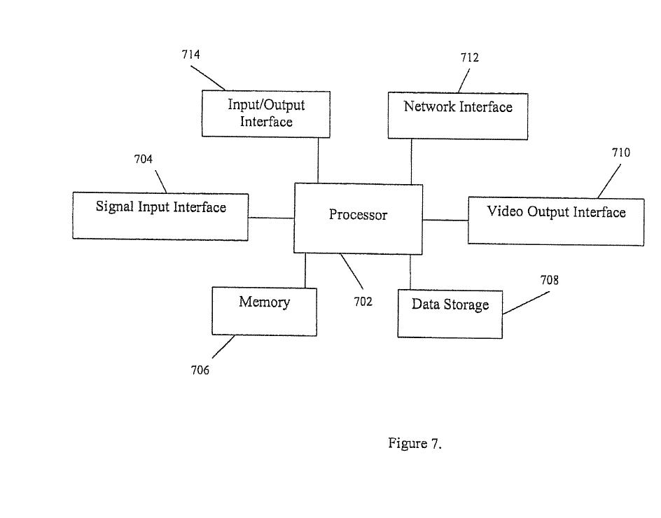

One embodiment of signal processing system 104 shown in earlier FIG. 1 may be implemented as a personal computer (PC). As shown in FIG. 7, a PC may be any type of well-known computer comprising processor 702, memory 706, data storage 708, user input/output interface 714, and network interface 712. It may further comprise signal input interface 704 and video output interface 710. Data storage 708 may comprise a hard drive or non-volatile memory. User input/output interface 714 may comprise a connection to a keyboard or mouse. Signal input interface 704 may transform incoming signals to signals capable of being processed by processor 702. Video output interface 710 may transform signals from processor 702 to signals which may drive a video controller. Network interface 712 may comprise a connection to an Internet Protocol (IP) network. As is well known, a PC operates under control of computer software which defines the overall operation of the computer and applications. PCs are well known in the art and will not be described in detail herein.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for increasing the perceived monochrome luminance values of a color display system capable of displaying a plurality of pixels, each pixel comprising a red color component, a blue color component, and a green color component, wherein the luminance of each color component is independently controllable according to an n-bit control value, and wherein each pixel is capable of displaying a plurality of true monochrome luminance values by setting the luminance of each color component of a pixel to a same n-bit control value thereby allowing the display of 2ⁿ true monochrome luminance values, the method comprising the steps of:
receiving input digital image values comprising greater than 2ⁿ true monochrome luminance values; and
generating intermediate perceived monochrome luminance values between first and second true monochrome luminance values by varying the n-bit control values of the color components of a pixel such that at least two of the n-bit control values of the color components of the pixel are different from each other.

2. The method of claim 1 wherein said step of generating intermediate perceived monochrome luminance values between two true monochrome luminance values by varying the n-bit control values of the color components of a pixel further comprises the steps of:
generating a first intermediate perceived monochrome level by adding 1 bit to the control value of the blue color component of the first true monochrome luminance value;
generating a second intermediate perceived monochrome level by adding 1 bit to the control value of the red color component of the first true monochrome luminance value;
generating a third intermediate perceived monochrome level by adding 1 bit to each of the control values of the blue color component and the red color component of the first true monochrome luminance value;
generating a fourth intermediate perceived monochrome level by adding 1 bit to the control value of the green color component of the first true monochrome luminance value;
generating a fifth intermediate perceived monochrome level by adding 1 bit to each of the control values of the blue color component and the green color component of the first true monochrome luminance value; and
generating a sixth intermediate perceived monochrome level by adding 1 bit to each of the control values of the red color component and the green color component of the first true monochrome luminance value.

3. The method of claim 1 wherein said input digital image values comprise 2^{n+x} true monochrome luminance levels, said method further comprising the step of:
mapping said input digital image value to an n-bit true monochrome luminance level and an intermediate perceived monochrome luminance level using a look-up table.

4. The method of claim 1 wherein said input digital image values comprise 2^{n+x} true monochrome luminance levels, said method further comprising the step of:
setting an n-bit true monochrome luminance level equal to n most significant bits of said digital image value; and
calculating an intermediate perceived monochrome luminance level from x least significant bits of said digital image value.

5. A system for increasing the perceived monochrome luminance values of a color display system capable of displaying a plurality of pixels, each pixel comprising a red color component, a blue color component, and a green color component, wherein the luminance of each color component is independently controllable according to an n-bit control value, and wherein each pixel is capable of displaying a plurality of true monochrome luminance values by setting the luminance of each color component of a pixel to a same n-bit control value thereby allowing the display of 2ⁿ true monochrome luminance values, the system comprising:
means for receiving input digital image values comprising greater than 2ⁿ true monochrome luminance values; and
means for generating intermediate perceived monochrome luminance values between first and second true monochrome luminance values by varying the n-bit control values of the color components of a pixel such that at least two of the n-bit control values of the color components of the pixel are different from each other.

6. The system of claim 5 wherein said means for generating intermediate perceived monochrome values between two true monochrome luminance values by varying the n-bit control values of the color components of a pixel further comprises:
means for generating a first intermediate perceived monochrome level by adding 1 bit to the control value of the blue color component of the first true monochrome luminance value;
means for generating a second intermediate perceived monochrome level by adding 1 bit to the control value of the red color component of the first true monochrome luminance value;
means for generating a third intermediate perceived monochrome level by adding 1 bit to each of the control values of the blue color component and the red color component of the first true monochrome luminance value;
means for generating a fourth intermediate perceived monochrome level by adding 1 bit to the control value of the green color component of the first true monochrome luminance value;
means for generating a fifth intermediate perceived monochrome level by adding 1 bit to each of the control values of the blue color component and the green color component of the first true monochrome luminance value; and
means for generating a sixth intermediate perceived monochrome level by adding 1 bit to each of the control values of the red color component and the green color component of the first true monochrome luminance value.

7. The system of claim 5 wherein said input digital image values comprise 2^{n+x} true monochrome luminance levels, said system further comprising:
means for mapping said input digital image value to an n-bit true monochrome luminance level and an intermediate perceived monochrome luminance level using a look-up table.

8. The system of claim 5 wherein said input digital image values comprise 2^{n+x} true monochrome luminance levels, said system further comprising:
means for setting an n-bit true monochrome luminance level equal to n most significant bits of said digital image value; and
means for calculating an intermediate perceived monochrome luminance level from x least significant bits of said digital image value.

9. A computer readable medium storing computer program instructions for increasing the perceived monochrome luminance values of a color display system capable of displaying a plurality of pixels, each pixel comprising a red color component, a blue color component, and a green color component, wherein the luminance of each color component is independently controllable according to an n-bit control value, and wherein each pixel is capable of displaying a plurality of true monochrome luminance values by setting the luminance of each color component of a pixel to a same n-bit control value thereby allowing the display of 2ⁿ true monochrome luminance values, the computer program instructions defining the steps of:
receiving input digital image values comprising greater than 2ⁿ true monochrome luminance values; and
generating intermediate perceived monochrome luminance values between first and second true monochrome luminance values by varying the n-bit control values of the color components of a pixel such that at least two of the n-bit control values of the color components of the pixel are different from each other.

10. The computer readable medium of claim 9 wherein said computer program instructions defining the step of generating intermediate perceived monochrome values between two true monochrome luminance values by varying the n-bit control values of the color components of a pixel further comprise computer program instructions defining the steps of:
generating a first intermediate perceived monochrome level by adding 1 bit to the control value of the blue color component of the first true monochrome luminance value;
generating a second intermediate perceived monochrome level by adding 1 bit to the control value of the red color component of the first true monochrome luminance value;
generating a third intermediate perceived monochrome level by adding 1 bit to each of the control values of the blue color component and the red color component of the first true monochrome luminance value;
generating a fourth intermediate perceived monochrome level by adding 1 bit to the control value of the green color component of the first true monochrome luminance value;
generating a fifth intermediate perceived monochrome level by adding 1 bit to each of the control values of the blue color component and the green color component of the first true monochrome luminance value; and
generating a sixth intermediate perceived monochrome level by adding 1 bit to each of the control values of the red color component and the green color component of the first true monochrome luminance value.

11. The computer readable medium of claim 9 wherein said input digital image values comprise 2^{n+x} true monochrome luminance levels, said computer program instructions further defining the step of:
mapping said input digital image value to an n-bit true monochrome luminance level and an intermediate perceived monochrome luminance level using a look-up table.

12. The computer readable medium of claim 9 wherein said input digital image values comprise 2^{n+x} true monochrome luminance levels, said computer program instructions further defining the step of:
setting an n-bit true monochrome luminance level equal to n most significant bits of said digital image value; and
calculating an intermediate perceived monochrome luminance level from x least significant bits of said digital image value.
